(19) United States
(12) Patent Application Publication
(10) Pub. No.: US 2005/0065757 A1
(43) Pub. Date: Mar. 24, 2005

(54) System and method for estimating displacement of a seat-belted occupant

(76) Inventor: Samer R. White, West Bloomfield, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/666,171

(22) Filed: Sep. 19, 2003

(51) Int. Cl. G06G 7/48

(52) U.S. Cl. 703/8

(57) ABSTRACT

A method and system for estimating the amount of forward displacement undergone by a seat-belted occupant of a vehicle. A test dummy, representing the seat-belted occupant, is pivotably restrained at a first point with respect to a fixed frame of reference. A second point associated with the test dummy is subsequently subjected to a measurable amount of forward displacement with respect to the same frame of reference, causing the test dummy to lean or tilt forward. An amount of forward displacement that occurs at a third point on or adjacent to the test dummy is then estimated through the use of ratios.

### FIELD OF THE INVENTION

The present invention relates to the field of vehicle safety systems. More specifically, the present invention relates to a system for simulating the movement of a seat-belted occupant of a vehicle, along with a method of estimating the amount of horizontal displacement undergone by the seat-belted occupant.

### BACKGROUND OF THE INVENTION

Vehicle manufactures frequently utilize various systems and methods to simulate an occupant of a vehicle during sudden deceleration. These simulations typically allow the vehicle manufactures to predict the types of movement that the body of a vehicle occupant will undergo during a moment of sudden vehicle deceleration. The simulation results are then used to evaluate and improve various safety features found in modern vehicles. One such recent feature has been smart air bag systems, which monitor the actual position and motion of an occupant's body to determine an appropriate course of action.

In order to develop and test systems such as smart airbags, manufacturers need to be able to simulate and map the position and motion of a vehicle occupant during various conditions. However, existing methods of simulating the motion of a vehicle occupant are unable to provide a quick and simple way of accurately simulating the movement of a seat-belted occupant during a moment of vehicle deceleration and then estimate the resulting displacement of the seat-belted occupant from his original position. Accordingly, the inventor of the present invention has developed a system and method for easily simulating the movement of a seat-belted occupant and estimating the amount of forward displacement that the occupant would be subject to due to sudden deceleration of the vehicle.

### SUMMARY OF THE INVENTION

The present invention relates to the field of vehicle safety, and more specifically, to a system and method of simulating the movement of a seat-belted occupant of a vehicle by subjecting a first, fixed point associated with a test dummy to a measurable amount of forward displacement with respect to a fixed frame of reference while limiting the amount of forward displacement that can occur at a second fixed point associated with the dummy with respect to the same frame of reference. Through the use of ratios, an amount of overall forward displacement undergone by the test dummy can then be estimated.

### BRIEF DESCRIPTION OF THE DRAWINGS

FIG. 1 is a simplified illustration of a system for simulating a seat-belted occupant according to one embodiment of the present invention.

FIG. 2 is a simplified illustration of how the system of FIG. 1 operates.

FIG. 3 illustrates the various distances and displacements used to determine the amount of horizontal or forward displacement that a seat-belted occupant may experience during deceleration of their vehicle.

### DESCRIPTION OF THE PREFERRED EMBODIMENT

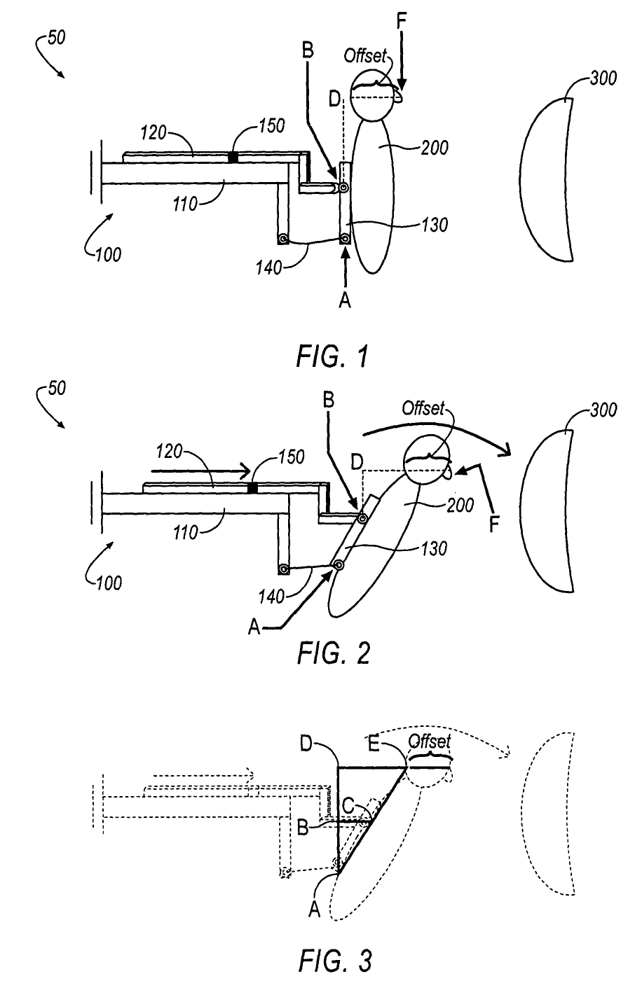

A preferred embodiment of the present invention will now be described with reference to FIGS. 1 through 3. In general, a seat-belted occupant simulator 50 comprises two sections, including a mount 100 and an attached test dummy 200. Mount 100 includes a support guide 110 that establishes a fixed frame of reference with respect to the test dummy 200. Support guide 110 can be selectively fixed to a stationary structure, such as a wall or floor. Alternatively, mount 100 can be selectively fixed to an appropriate mobile structure, thereby allowing the simulator 50 to be easily moved from one location to another.

Located on support guide 110 is a drive guide 120 that is capable of being linearly displaced back and forth along the support guide 110. Movement of drive guide 120 relative to support guide 110 can be accomplished in numerous ways, ranging from something as simple as a human operator manually displacing drive guide 120 relative to support guide 110, to something more complex, such as a computer-controlled motor capable of accurately displacing drive guide 120 for various predetermined distances at one or more selectable velocities (not shown). To measure how much drive guide 120 is extended or displaced relative to support guide 110 at any moment in time, a displacement monitor 150 is incorporated into the mount system 100.

According to the present embodiment, a support brace 130 is affixed to the test dummy 200. Drive guide 120 then supports test dummy 200 by connecting to the support brace 130. As illustrated in the Figures, drive guide 120 connects to support brace 130 at point B. This connection at point B between drive guide 120 and support brace 130 functions as a pivot point, allowing the support brace 130, and subsequently the test dummy 200 affixed to support brace 130, to pivot or rotate about point B.

In order to simulate the tilting or leaning motion of a seat-belted occupant, one end of test dummy 200 must generally be fixed with respect to the fixed frame of reference represented in the current embodiment by the support guide 110. This is accomplished by various restraining systems 140 that, in general, prevent the fixed end of the test dummy 200 from undergoing any forward-directed lateral displacement. According to a first embodiment, not illustrated, restraining system 140 can comprise some form of mechanical or electromechanical brake or catch that secures point A of the mounting brace 130 from undergoing any forwardly-directed displacement relative to the support guide 110. For example, restraining system 140 can comprise a rigid bar or member that is fixed in length, and thus cannot be shortened through compaction or lengthened through extension. One end of the rigid member attaches to a point on the fixed frame of reference, such as one end of the support guide 110. The other end of the rigid member attaches either to the test dummy 200 or to the mounting brace 130 in such a manner that the test dummy 200 is restricted from any linear displacement in either a forwards or backwards direction with respect to the established fixed frame of reference. At the same time, however, the rigid member connects to the support brace 130 or test dummy 200 in such a manner as to allow the support brace 130 and/or test dummy 200 to rotate or pivot about the connection point.

According to an alternate embodiment, as illustrated in the Figures, the restraining system comprises a flexible tether 140 that connects in-between support guide 110 and point A on the support brace 130. As in the prior embodiment discussed above, the connection at point A functions as a pivot point, permitting the support brace 130 and/or test dummy 200 to pivot or rotate about point A. However, unlike the prior embodiment, the flexible tether 140 prevents point A of the support brace 130 from undergoing any forward-directed displacement, relative to the support guide 110, only after the drive guide 120 has been extended by an amount that equals the length of the flexible tether 140. Accordingly, in this embodiment of the invention, simulations should only be considered active once the tether 140 is fully extended, thus assuring that point A of the support brace 130 cannot undergo any further forward-directed displacement.

To assure that measurements are taken only after tether 140 has been fully extended, an angle sensor or inclinometer (not shown) can be incorporated into the simulator system 50 at point B. Upon drive guide 120 extending far enough to equal the length of tether 140, the test dummy 200 will begin to tilt forward. The inclinometer mounted at point B will detect the tilting motion of test dummy 200 and can be setup to mark that point in time and space as the starting or reference point for all subsequent measurements or estimates obtained through use of the simulator system 50.

Operation of the seat-belted occupant simulator 50 will now be described with reference to the Figures. According to a first example, it is presumed that test dummy 200 is initially placed in a vertical orientation so that the length of test dummy 200 lies perpendicular to the length of the support guide 110. This vertical orientation, as illustrated in FIG. 1, best represents a vehicle occupant sitting upright in their seat. The motion that a vehicle occupant subsequently undergoes upon sudden deceleration of their vehicle is simulated by displacing drive guide 120 in a forward direction. This results in an upper portion of the test dummy 200 being displaced forward relative to the fixed frame of reference while the lower portion of the test dummy 200 is held in place due to the restraint system 140. Consequently, the test dummy 200 undergoes a tilting motion similar to that of a seat-belted occupant, leaning both forward and downward.

For purposes of evaluating safety systems such as seat belts and air bags, it is advantageous for a vehicle manufacturer to be able to estimate the amount of forward displacement undergone by an occupant's body at any point during a sudden deceleration situation. The seat-belted occupant simulator 50 is advantageous in this respect as it subsequently allows for an easy and rapid estimation of the amount of forward displacement undergone by the test dummy 200 by means of a simple ratio comparison.

When a vehicle occupant is caught in a state of sudden deceleration and their body is leaning or tilting forward, the outermost part of their body that faces in a forward direction will be the first portion of their body to likely impact the dashboard 300 or trigger an air-bag system. In the embodiment illustrated in the Figures, this outermost part of an occupant is presumed to be the nose, illustrated as point F on the test dummy 200, although any point on the test dummy 200 could be utilized.

To estimate the amount of forward displacement undergone by the outermost region (point F) of the test dummy 200, one must first determine the distance that drive guide 120 has been displaced in the forward direction relative to the support guide 110. If the restraint system 140 that is being utilized is based on a flexible tether, then this determined amount of displacement must be evaluated in relation to the amount of forward displacement inherently allowed by the flexible tether. The overall amount of forward displacement undergone by drive guide 120 must then be reduced by the amount of displacement allowed by the tether, which is equivalent to the tether length. In the illustrated embodiment, the adjusted distance is graphically depicted in FIG. 3 as the line connecting the two points labeled B and C, respectively. This distance BC can then be related to the distance or amount of forward displacement undergone by the upper portion of the test dummy 200, indicated in FIG. 3 as the line connecting the two labeled points D and E. Specifically, the ratio DE/BC is assumed to be equal to the ratio of the distances AD/AB, where AD is the distance between point A on said mounting brace 130, and point D, representing the vertical height of the selected outermost point F of the test dummy 200. Similarly, distance AB represents the vertical distance that exists between points A and B on said mounting brace 130. As points A, B and D are all known, distances AB and AD, which are at right angles to distances BC and DE, can be readily determined. Knowing distances BC, AB and AD, unknown distance DE can then be readily estimated through the relationship:
DE=BC*(AD/AB)
Resultant distance DE represents the relative amount of horizontal or forward displacement undergone by the upper portion of test dummy 200. However, it does not take into account the position of the outermost part of the test dummy 200, represented by point F. Accordingly, an offset representing the distance between point D and point F must be added to the calculated distance DE. The resultant amount of forward displacement undergone by test dummy 200 is then seen to be:
Displacement=BC*(AD/AB)+DF
In the above equation, the estimated offset distance DF is readily predetermined through measurement.

In addition to the distance or amount of forward displacement undergone by the test dummy, once can also readily estimate the velocity that the test dummy was subject to during its displacement. This is accomplished by simply recording the amount of time required to displace the test dummy from its initial starting position to its final displaced state, and then dividing the test dummy's estimated amount of forward displacement by this recorded amount of time.

While the invention has been specifically described in connection with certain specific embodiments thereof, it is to be understood that this is by way of illustration and not of limitation, and the scope of the appended claims should be construed as broadly as the prior art will permit.

1. A method of simulating movement of a seat-belted occupant and estimating an amount of forwardly-directed displacement undergone by said seat-belted occupant with respect to an occupant's seat, comprising the steps of:
securing a test dummy at a first point that is both fixed with respect to said test dummy and fixed with respect to a fixed frame of reference, said first point selectively acting as a pivot point for said test dummy;
applying a linear force to a second point that is fixed with respect to said test dummy and offset from said first point, said linear force causing a measurable amount of forward-directed displacement of said second point with respect to said fixed frame of reference while causing said test dummy to pivot about said first point;
establishing a third point that is fixed with respect to said test dummy and offset from said first point and said second point, said third point undergoing an amount of forward-directed displacement with respect to said fixed frame of reference due to said pivoting of said test dummy; and
estimating an amount of said forward-directed displacement occurring at said third point by multiplying said measurable amount of forward-directed displacement occurring at said second point by a ratio AD/AB, where AD represents a distance between said first point and said third point and where AB represents a distance between said first point and said second point.

2. The method according to claim 1, further comprising the step of adjusting said estimated amount of forward-directed displacement occurring at said third point to account for a difference between a location of said third point and a location of an outermost point of said test dummy most likely to first make contact with an object or defined region of space lying in front of said test dummy.

3. The method according to claim 2, wherein said outermost point of said test dummy is a nose of said test dummy.

4. The method according to claim 2, wherein said adjusting step comprises the addition of an offset representing a distance between said third point and said outermost point of said test dummy.

5 The method according to claim 1, further comprising the step of restraining said first point to said fixed frame of reference by means of a rigid, non-extendable member, with one end of said member attaching to said fixed frame of reference while an opposite end of said member attaches to said first point.

6. The method according to claim 1, further comprising the step of restraining said first point to said fixed frame of reference by means of a flexible tether, with one end of said tether attaching to said fixed frame of reference while an opposite end of said tether attaches to said first point, said tether restricting forward displacement of said first point with respect to said fixed frame of reference once said measurable amount of forward-directed displacement of said second point is equal to a length of said tether.

7. The method according to claim 1, further comprising the steps of:
measuring an amount of time that said test dummy was subject to said application of said linear force; and
estimating a velocity of said test dummy by dividing said estimated amount of forward-directed displacement by said measured amount of time.

8. A system for simulating a seat-belted occupant of a vehicle and estimating an amount of forwardly-directed displacement of said occupant, comprising:
a test dummy representing the seat-belted occupant;
a first point fixed with respect to said test dummy and with respect to a fixed frame of reference, said first point selectively acting as a pivot point for said test dummy;
a second point fixed with respect to said test dummy and offset with respect to said first point; and
a third point fixed with respect to said test dummy and offset with respect to said first point and said second point,
wherein application of a linear component of a force at said second point causes a measurable amount of forward-directed linear displacement of said second point with respect to said fixed frame of reference while pivoting said test dummy about said first point in both a forward and downward direction, said pivoting of said test dummy resulting in forward displacement of said third point with respect to said fixed frame of reference, said forward displacement of said third point being estimated by multiplying said measurable amount of forward displacement of said second point by a ratio AD/AB, where AD represents a distance between said first point and said third point and where AB represents a distance between said first point and said second point.

9. The system according to claim 8, wherein said fixed frame of reference comprises a support guide upon which said test dummy is movably supported.

10. The system according to claim 9, further comprising a drive guide associated with said support guide, said drive guide pivotably supporting said test dummy and capable of being linearly displaced along said support guide in both a forwards and backwards direction.

11. The system according to claim 10, further comprising a support brace affixed to said test dummy and connecting said test dummy to said drive guide.

12. The system according to claim 11, wherein said first and second points are located on said support brace, and said third point is located on said test dummy.

13. The system according to claim 9, further comprising a restraining system that fixes said first point with respect to said support guide.

14. The system according to claim 12, further comprising a restraining system that fixes said first point with respect to said support guide.

15. The system according to claim 13, wherein said restraining system comprises a rigid, non-extendable member, with one end of said member attaching to said support guide while an opposite end of said member attaches to said first point.

16. The system according to claim 13, wherein said restraining system comprises a flexible tether, with one end of said tether attaching to said support guide while an opposite end of said tether attaches to said first point, said tether restricting forward-directed displacement of said first point with respect to said fixed frame of reference once said measurable amount of forward-directed linear displacement of said second point is equal to a length of said tether.

17. The system according to claim 16, wherein said estimation of said forward displacement occurring at said third point is established with respect to a starting position of said test dummy, said starting position corresponding to a state of said system where any forward displacement at said second point results in said test dummy beginning to tilt about said first point.

18. The system according to claim 17, further comprising an inclinometer mounted at or nearby said second point, said inclinometer detecting when said test dummy begins to tilt about said first point, thereby indicating when said test dummy is in said starting position.

19. The system according to claim 18, wherein said estimated displacement of said third point is adjusted to account for a difference between a location of said third point and a location of an outermost point of said test dummy, said outermost point of said test dummy being that portion of said test dummy most likely to first make contact with an object or defined region of space lying in front of said test dummy.

20. The system according to claim 19, wherein said adjustment of said estimated displacement of said third point includes the addition of an offset representing a distance between said third point and said outermost point of said test dummy.

21. The system according to claim 8, wherein a velocity of said test dummy can be estimated by dividing said estimated amount of forward displacement of said third point by an amount of time during which said test dummy underwent displacement due to application of said linear component of said force at said second point.
